(19) United States
(12) Patent Application Publication
(10) Pub. No.: US 2011/0162951 A1
(43) Pub. Date: Jul. 7, 2011

(54) PARTIAL PRESSURE DISTILLATION PROCESS

(75) Inventors: William W. Berry, Lakeland, FL (US); Mark G. Tegen, Gig Harbor, WA (US); William Rusty Sutterlin, Hoover, AL (US); Stephen L. Hillis, Lakeland, FL (US)

(73) Assignee: Inventure Chemical, Inc., Gig Harbor, WA (US)

(21) Appl. No.: 12/835,380

(22) Filed: Jul. 13, 2010

Related U.S. Application Data
(60) Provisional application No. 61/225,095, filed on Jul. 13, 2009.

(51) Int. Cl. B01D 3/34; C10B 57/12

(52) U.S. Cl. 201/36; 203/42

(57) ABSTRACT

A method for separating at least one volatile component such as an alkyl ester, an alcohol, hydroxymethylfuran, dimethylfuran, methyl tetrahydrofuran, a polyhydric alcohol, or a reduction product of a polyhydric alcohol from at least one non-volatile component such as a saccharide, a peptide, or ash in a mixture is disclosed. The method includes heating the mixture to a temperature of between 150-250° C. and contacting the mixture with a superheated distillation alcohol in a gaseous or vapor phase. The distillation alcohol pressure imparts partial vapor pressure on the at least one volatile component of the mixture and distills at least a portion of the at least one volatile component from the mixture.

### REFERENCE TO RELATED APPLICATIONS

This application claims the benefit of U.S. Provisional Patent Application Ser. No. 61/225,095, filed on Jul. 13, 2009, which is incorporated herein by reference in its entirety.

### FIELD OF THE INVENTION

The invention relates to methods and apparatus for separating volatile components from non-volatile components in a mixture. In one embodiment, the invention relates to methods and apparatus for separating volatile components from non-volatile components in the processing of biomass into biofuels.

### BACKGROUND OF THE INVENTION

In biodiesel manufacturing, refined and extracted vegetable oils such as corn oil, soybean oil, canola oil, grape seed oil, and palm oil or animal fats, etc. are typically reacted with an alcohol and a base catalyst to trans-esterify the triglyceride into alkyl esters and a glycerin/catalyst bottoms mixture. Current reaction systems are typically batch or continuous systems. In general, at least a 100% stoichiometric excess of alcohol is used to drive the trans-esterification reaction. When the reaction is completed the excess alcohol is removed from the reaction vessel by vacuum stripping or, alternatively, removed from a separate stripping vessel by vacuum stripping. The resulting alkyl esters are typically purified by settling and subsequent acidulation and flocculation to remove the glycerin/catalyst bottoms, by treatment via water washing and drying; sorbent treatment; or ion exchange, by vacuum distillation to further purify the resulting alkyl ester from the non-volatile components, or by a combination of these procedures. The resulting alkyl esters are then sufficiently purified to be sold into transportation fuel markets.

In the case of the vacuum distillation of methyl esters, liquid/solid or liquid/liquid mixtures are heated and subjected to very high vacuum in order to evaporate the ester fraction from the feed solution. The ester vapor is condensed and cooled. The current vacuum approach to ester distillation requires very high vacuum and associated processing equipment.

### BRIEF SUMMARY OF THE INVENTION

The present invention relates to methods and apparatus for separating volatile components from non-volatile components in a mixture. In one embodiment, the invention is directed to a method for separating volatile components such as alkyl esters, alcohols, hydroxymethylfuran, dimethylfuran, methyl tetrahydrofuran, polyhydric alcohols, and the reduction products of polyhydric alcohols from non-volatile components in a mixture comprising heating the mixture to between 150° C. and 250° C., contacting the mixture with a distillation alcohol that is vaporized or in a gaseous phase and distilling at least a portion of the volatile components from the mixture. In some embodiments, the mixture is contacted with a distillation alcohol that is superheated. The distillation alcohol imparts a partial vapor pressure on the volatile components. Preferably, the mixture is contacted with the distillation alcohol at about atmospheric pressure or under a moderate vacuum. In some embodiments, the mixture comprises biodiesel or a biodiesel starting material including, but not limited to corn oil, soybean oil, canola oil, grape seed oil, palm oil, algae oil, oil derived from bacteria, oil derived from cyanobacteria, oil derived from yeast, animal fats, used cooking oils, and the like.

In other embodiments, the method further comprises separating the distillation alcohol from at least one of the distilled volatile components after distilling at least a portion of the volatile components from the mixture. For example, at least one distilled volatile component can be separated from the distillation alcohol by reducing the temperature of the distilled volatile component below its dew point, while leaving the alcohol vapor at a temperature above its boiling point.

In some embodiments, the method further comprises reheating the distillation alcohol after separating the distillation alcohol from at least one distilled volatile component and recycling the distillation alcohol to a distillation alcohol vessel or to a stripping vessel. In still other embodiments, the method further comprises continuously removing at least one of the non-volatile components from the mixture. For example, at least one of the non-volatile components can be continuously removed from the mixture using a screw auger; if solids are present in the non-volatile liquid or if the non-volatile liquid is viscous, a slurry pump can be used to remove the non-volatile components.

In some embodiments, at least one volatile component is alkyl esters and the distillation alcohol to alkyl ester molar ratio is from 1:1 to 500:1. In other embodiments, at least one volatile component is glycerol and the distillation alcohol to glycerol molar ratio is from 1:1 to 500:1. In another embodiment, the distillation alcohol partial vapor pressure is from 100 mm Hg (about 13.3 kPa) to 7,600 mmHg (about 1011 kPa).

In one embodiment, the invention is directed to an apparatus for separating volatile components comprising at least one of alkyl esters, alcohols, hydroxymethylfuran, dimethylfuran; methyl tetrahydrofuran, polyhydric alcohols, and the reduction products of polyhydric alcohols from non-volatile components in a mixture, wherein the apparatus comprises a stripping vessel, at least one intake port defined by the stripping vessel for receiving the mixture, at least one distillation alcohol port defined by the stripping vessel for receiving a distillation alcohol, and at least one exit port defined by the stripping vessel for discharging distilled volatile components and distillation alcohol vapor.

In some embodiments, the apparatus further comprises at least one discharge port defined by the stripping vessel for discharging non-volatile components. In other embodiments, the apparatus further comprises a plurality of baffles disposed within the stripping vessel. In some embodiments, the baffles are disposed on the internal surface of at least one wall of the stripping vessel. In still other embodiments, the apparatus further comprises a condenser configured and arranged to condense at least one distilled volatile component discharged through the exit port. In yet other embodiments, the apparatus further comprises a distillation alcohol recycle port defined by the stripping vessel for introducing distillation alcohol that has been separated from at least one distilled volatile component of the mixture.

In another embodiment, the apparatus further comprises a product collection vessel configured and arranged to receive at least one distilled volatile component. In yet another embodiment, the apparatus further comprises a distillation alcohol collection vessel configured and arranged to receive a distillation alcohol that has been separated from a distilled volatile component.

In some embodiments, the distillation alcohol port is configured and arranged to introduce a distillation alcohol at the bottom of the stripping vessel. In other embodiments, the stripping vessel is a column of sufficient volume to allow for vapor space contact time between the mixture and a distillation alcohol vapor. For example, the stripping vessel can optionally be configured and arranged to increase or maximize the surface area of the mixture that is contact with the distillation alcohol vapor

### BRIEF DESCRIPTION OF THE DRAWINGS

FIG. 1 depicts one embodiment of a method and a small scale apparatus used to separate volatile components from non-volatile components in a liquid mixture. The flexible connectors can be made, e.g., from high temperature silicon tubing. The elbows and methanol heating run can be made, e.g., from stainless instrument tubing. Both the elbows and the heating run can be, e.g., ¼ inch diameter tubing.

FIG. 2 depicts one embodiment of a method and apparatus used to separate volatile components from non-volatile components in a solid mixture.

### DETAILED DESCRIPTION OF THE INVENTION

The invention is directed, in part, to a method for separating volatile components from non-volatile components in a mixture using a vaporized solvent to distill the volatile components from the non-volatile components. In the method, the volatile components are stripped from a substantial amount of non-volatile components such as amino acids, proteins, carbohydrates, and minerals. Unlike vacuum distillation in which a mixed feed stream is nearly 100% volatile, the mixture prior to separation of the present invention is typically comprised of about 25% volatile material, but may be considerably higher or lower. Moreover, the present method occurs at a lower temperature and shorter residence time compared to vacuum distillation resulting in less degradation of the solid, non-volatile materials. Additionally, unlike chemical reactions in which a gaseous reactant is mixed with a secondary reagent carrier gas, no chemical reaction is taking place, and only distillation, or vapor stripping, occurs in the present invention.

The mixture prior to separation can be a liquid mixture, a solid mixture or a mixture of both solids and liquids. In some embodiments, the mixture comprises biodiesel or a biodiesel starting material including, but not limited to corn oil, soybean oil, canola oil, grape seed oil, palm oil, algae oil, oil derived from bacteria, oil derived from cyanobacteria, oil derived from yeast, animal fats, used cooking oils, and the like. As used herein, “biodiesel” refers to a non-petroleum-based fuel that includes short chain alkyl (methyl or ethyl) esters that is made by transesterification of oils such as corn oil, soybean oil, canola oil, grape seed oil, palm oil, animal fats, or the like. Methods of producing biodiesel by esterification or transesterification reactions are described in, for example, U.S. patent application Ser. No. 12/061,038 (filed Apr. 2, 2008) and U.S. patent application Ser. No. 12/243,933 (filed Oct. 1, 2008), which are hereby incorporated by reference in their entirety.

The method includes heating the mixture containing the volatile and non-volatile components to an operating temperature of between 150° C. and 250° C. For example, the mixture can be heated to an operating temperature of between 150° C. and 250° C., between 170° C. and 230° C., or between 190° C. and 210° C. In some embodiments, the mixture is heated to 150° C., 160° C., 170° C., 180° C., 190° C., 200° C., 210° C., 220° C., 230° C., 240° C., or 250° C. At the operating temperature, at least a portion of at least one volatile component in the mixture is vaporized or in a gaseous phase.

A volatile component is a material that exists in a gaseous phase or that is vaporized when the mixture is at the operating temperature and pressure. Examples of volatile components include, for example, alcohols, alkyl esters including mixed alkyl esters and alkyl diesters, hydroxymethylfuran, dimethylfuran, methyl tetrahydrofuran, polyhydric alcohols (such as glycol, glycerol, xylitol, and sorbitol), and the reduction products of polyhydric alcohols. Typically, the volatile components in the mixture are in an amount of less than about 50 wt %, from about 10 wt % to about 40 wt %, or from about 20 wt % to about 30 wt % of the mixture prior to separation. However, the volatile components can comprise up to about 100% of the mixture to be separated.

A non-volatile component is a material that exists in a solid or liquid phase when the mixture is at the operating temperature and pressure. Examples of non-volatile components include, for example, saccharides, peptides, amino acids, proteins, carbohydrates, minerals, ash, acrylic esters, acetic esters, sugar acid esters, methyl glucosides, and ethyl glucosides.

The heated mixture is contacted with a superheated distillation alcohol that is in a gaseous phase or that is vaporized. In some embodiments, the heated mixture is contacted with the superheated distillation alcohol in an air environment. In other embodiments, the heated mixture is contacted with the superheated distillation alcohol in an inert environment such as a nitrogen environment. In other embodiments, the heated mixture can be contacted with a vapor that is about 100% superheated alcohol without additional vapor diluents. The distillation alcohol can be at any temperature at which the distillation alcohol is superheated and is in a gaseous phase or vaporized. For example, the distillation alcohol can be at a temperature of 150° C. to 250° C., 170° C. to 230° C., or 190° C. to 210° C. The distillation alcohol may be at a temperature of 150° C., 160° C., 170° C., 180° C., 190° C., 200° C., 210° C., 220° C., 230° C., 240° C., or 250° C.

Any alcohol may be used as a distillation alcohol including, for example, methanol, ethanol, propanol, isopropanol, butanol, hexanol, octanol, decanol, and dodecanol.

The distillation alcohol is contacted with the heated mixture for from about 2 seconds to about 60 seconds or from about 15 seconds to about 25 seconds.

The heated mixture is preferably contacted with the superheated distillation alcohol at about atmospheric pressure or under a moderate vacuum to distill one or more volatile components from the mixture in combination with the distillation alcohol. Atmospheric pressure is the pressure at any given point in the earth's atmosphere. Those skilled in the art will understand that atmospheric pressure decreases with increasing elevation. It will also be understood that a standard atmosphere is 101.325 kPa, 760 mmHg (Torr), 29.92 inches Hg or 14.696 psi (pounds per square inch). A moderate vacuum is from atmospheric pressure (101.325 kPa, 760 mmHg (Torr)) to 1.333 kPa (10 Torr). As used herein, “about” means ±10% of the indicated value.

The distillation alcohol may be used in any molar ratio to the volatile components. Preferably, the distillation alcohol is provided in a molar excess to the volatile components of the mixture. The distillation alcohol to volatile component molar ratio for at least one volatile component may be from 1:1 to 500:1. The distillation alcohol to volatile component molar ratio can be, for example, 1:1, 10:1, 15:1, 20:1, 25:1, 50:1, 100:1, 150:1, 200:1, 250:1, 300:1, 350:1, 400:1, 450:1 or 500:1. In one embodiment, the volatile component includes alkyl esters and the alcohol to alkyl ester molar ratio is from 1:1 to 500:1. In another embodiment, the volatile component includes glycerol and the distillation alcohol to glycerol molar ratio is from 1:1 to 500:1.

Table 1 includes ChemCad simulations for several distillation alcohol:volatile component molar ratios. For example, the first row in Table 1 represents a simulation using a flow rate of 1.6021 kg/hour of methanol (50 moles/hour of methanol) and a flow rate of 0.2965 kg/hour of the biodiesel methyl oleate (1 mole/hour of methyl oleate) for a methanol:methyl oleate molar ratio of 50:1. The second row in Table 1 represents a simulation using a flow rate of 0.8011 kg/hour of methanol (25 moles/hour of methanol) and a flow rate of 0.2965 kg/hour of the methyl oleate (1 mole/hour of methyl oleate) for a methanol:methyl oleate molar ratio of 25:1. The third row in Table 1 represents a simulation using a flow rate of 0.4806 kg/hour of methanol (15 moles/hour of methanol) and a flow rate of 0.2965 kg/hour of methyl oleate (1 mole/hour of methyl oleate) for a methanol:methyl oleate molar ratio of 15:1.

TABLE 1
ChemCad Simulation of various ratios of
methanol to biodiesel/methyl oleate

| | Stream No. | | |
|---|---|---|---|
| | 1 | 2 | 3 |
| Stream Name | Biodiesel | Methanol | Mix |

Methanol to Biodiesel Ratio = 50:1

| | | | |
|---|---|---|---|
| Temp F. | 420.0000* | 420.0000* | 394.7513 |
| Pres bar | 1.0000* | 1.0000* | 1.0000 |
| Enth kW | −0.16529 | −2.6711 | −2.8364 |
| Vapor mole fraction | 0.00000 | 1.0000 | 0.99262 |
| Total kmol/h | 0.0010 | 0.0500 | 0.0510 |
| Total kg/h | 0.2965 | 1.6021 | 1.8986 |
| Total std L m3/h | 0.0003 | 0.0020 | 0.0023 |
| Total std V m3/h | 0.02 | 1.18 | 1.21 |
| Flowrates in kg/h | | | |
| Methanol | 0.0000 | 1.6021 | 1.6021 |
| Methyl Oleate | 0.2965 | 0.0000 | 0.2965 |

Methanol to Biodiesel Ratio = 25:1

| | | | |
|---|---|---|---|
| Temp F. | 420.0000* | 420.0000* | 397.8785 |
| Pres bar | 1.0000* | 1.0000* | 1.0000 |
| Enth kW | −0.16529 | −1.3355 | −1.5008 |
| Vapor mole fraction | 0.00000 | 1.0000 | 0.97390 |
| Total kmol/h | 0.0010 | 0.0250 | 0.0260 |
| Total kg/h | 0.2965 | 0.8010 | 1.0975 |
| Total std L m3/h | 0.0003 | 0.0010 | 0.0013 |
| Total std V m3/h | 0.02 | 0.59 | 0.62 |
| Flowrates in kg/h | | | |
| Methanol | 0.0000 | 0.8010 | 0.8011 |
| Methyl Oleate | 0.2965 | 0.0000 | 0.2965 |

Methanol to Biodiesel Ratio = 15:1

| | | | |
|---|---|---|---|
| Temp F. | 420.0000* | 420.0000* | 401.0101 |
| Pres bar | 1.0000* | 1.0000* | 1.0000 |
| Enth kW | −0.16529 | −0.80133 | −0.96661 |
| Vapor mole fraction | 0.00000 | 1.0000 | 0.94981 |
| Total kmol/h | 0.0010 | 0.0150 | 0.0160 |
| Total kg/h | 0.2965 | 0.4806 | 0.7771 |
| Total std L m3/h | 0.0003 | 0.0006 | 0.0009 |
| Total std V m3/h | 0.02 | 0.36 | 0.38 |
| Flowrates in kg/h | | | |
| Methanol | 0.0000 | 0.4806 | 0.4806 |
| Methyl Oleate | 0.2965 | 0.0000 | 0.2965 |

The distillation alcohol provides a partial vapor pressure. As will be understood by those of skill in the art, vapor pressure refers to the pressure of a vapor in equilibrium with its non-vapor phases (i.e., liquid or solid). In a mixture of ideal gases, each gas has a partial pressure that is the pressure that the gas would have if it alone occupied the volume. The total pressure of a gas mixture is the sum of the partial pressures of each individual gas in the mixture.

The distillation alcohol partial vapor pressure can be, for example, from 13.3 kPa (0.132 atm; 100 mmHg) to 133 kPa (1.32 atm; 1000 mmHg), from 133 kPa (1.32 atm; 1000 mmHg) to 1330 kPa (13.2 atm; 10,000 mmHg), from 1330 kPa (13.2 atm; 10,000 mmHg) to 2660 kPa (26.3 atm; 20,000 mmHg), from 2660 kPa (26.3 atm; 20,000 mmHg) to 3990 kPa (39.5 atm; 30,000 mmHg), from 3990 kPa (39.5 atm; 30,000 mmHg) to 5320 kPa (52.6 atm; 40,000 mmHg), from 5320 kPa (52.6 atm; 40,000 mmHg) to 6650 kPa (65.8 atm; 50,000 mmHg), or from 6650 kPa (65.8 atm; 50,000 mmHg) to 7866 kPa (77.6 atm; 59,000 mmHg). Preferably, the distillation alcohol partial vapor pressure is from 13.3 kPa (0.132 atm; 100 mmHg) to 1011 kPa (10 atm; 7,600 mmHg).

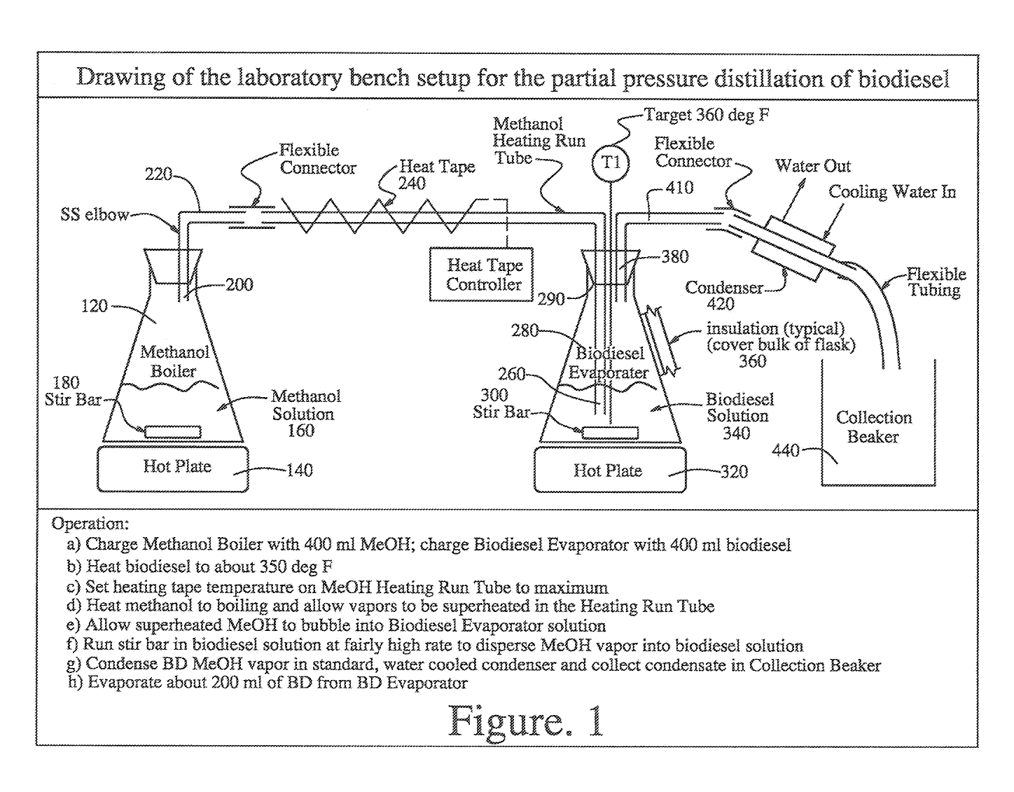

The invention is directed, in part, to an apparatus for separating volatile components from non-volatile components in a mixture. One embodiment of a method and small scale apparatus (such as a laboratory bench set-up) for separating volatile components from non-volatile components in a mixture is illustrated in FIG. 1. For larger systems (such as at a commercial level), the vessels would be larger and sized to match the specific process. Materials of construction would be chosen so as to be compatible with the materials handled, the vacuum anticipated, and the operating temperature of the system. The basic process flows and general methodology for vaporization would be similar for both the smaller scale and larger scale equipment systems.

In FIG. 1, a mixture 340 comprising biodiesel in liquid form is heated in a stripping vessel 280. The mixture 340 contains volatile components such as alcohols, alkyl esters including mixed alkyl esters and alkyl diesters, hydroxymethylfuran, dimethylfuran, methyl tetrahydrofuran, and glycerol (a polyhydric alcohol) as well as non-volatile components such as saccharides, peptides, ash, acrylic esters, acetic esters, sugar acid esters, methyl glucosides, and ethyl glucosides.

The stripping vessel 280 is heated by a heating element 320 such as, for example, a hot plate, furnace, or the like. A stirring element 300 may also be disposed in the stripping vessel 280 to stir the mixture and disperse the distillation alcohol that is introduced into the stripping vessel 280. A stirring element 300 can include, for example, a stir bar or a device that rotates the stripping vessel 280 to agitate the mixture 340.

As illustrated in FIG. 1, insulation 360 may be disposed around at least one side of the stripping vessel 280, such as a 1 liter flask with a silicon stopper. The stripping vessel 280 may be arranged in a vertical configuration. The stripping vessel 280 preferably has a significantly larger volume than the volume of the mixture 340 and allows for the mixture 340 to expand to fill the stripping vessel volume. For example, in some embodiments, the stripping vessel 280 has a volume that is 20%, 25%, 30%, 40%, 50%, 60%, 70%, 80%, 90%, 100%, or 150% greater than the volume of the mixture 340.

The stripping vessel 280 defines an intake port 290 through which the mixture 340 is introduced into the stripping vessel 280. The mixture 340 is preferably introduced at the top or middle of the stripping vessel 280.

The stripping vessel 280 also defines a distillation alcohol port 260 through which the stripping vessel 280 receives a superheated distillation alcohol 160 in a gaseous or vapor state. The distillation alcohol port 260 is preferably configured and arranged to allow the superheated distillation alcohol 160 in a gaseous or vapor phase to be introduced at the bottom of the stripping vessel 280 to affect a counter current flow to the mixture 340. The counter current contacting of the volatile materials with the distillation alcohol 160 vapor allows for the generation of a distillation alcohol vapor saturated with the volatile components.

In the embodiment illustrated in FIG. 1, the distillation alcohol 160 is heated to boiling in a distillation alcohol vessel 120, such as a 1 liter flask with a silicon stopper. The distillation alcohol 160 is heated by a distillation alcohol heating element 140 such as, for example, a hot plate, furnace, or the like. The distillation alcohol 160 may also be stirred with a distillation alcohol stirring element 180 such as a stir bar or element that rotates the distillation alcohol vessel 120.

In the embodiment illustrated in FIG. 1, the resulting distillation alcohol 160 vapor exits the distillation alcohol vessel 120 through a distillation alcohol vessel port 200 and travels to the stripping vessel 280 through a distillation alcohol supply line 220. The distillation alcohol vapor is preferably superheated to greater than 350° F. (177° C.). The distillation alcohol vapor can be superheated at any point before the distillation alcohol contacts the mixture 340. For example, the distillation alcohol can be superheated while in the distillation alcohol vessel 120 or while in the distillation alcohol supply line 220. In some embodiments, the distillation alcohol is superheated using a supply line heating element 240, such as heating tape made of silicon material with a 500° F. maximum rating, as illustrated in FIG. 1.

This superheated distillation alcohol 160 can then be passed into the heated mixture 340 by introducing the superheated distillation alcohol vapor into the stripping vessel 280 through a distillation alcohol port 260. The superheated distillation alcohol acts as a carrier gas to strip at least one volatile component (e.g., biodiesel) away. The resulting vapor stream includes distillation alcohol (e.g., methanol) and at least one volatile component (e.g., biodiesel).

In some embodiments, the resulting saturated vapor stream is then allowed to exit the stripping vessel 280 through an exit port 380 defined by the stripping vessel. Preferably, the exit port 380 is configured and arranged to allow the vapor stream comprised of volatile components and distillation alcohol vapor to be extracted from the top of the stripping vessel 380. The exit port 380 may be connected to a product outlet line 410 as shown in FIG. 1.

The volatile components may be condensed out of the distillation alcohol using a condenser 420. As illustrated in FIG. 1, the condenser 420 may be disposed around or connected to the product outline line 410. The condenser 420 drops the total temperature incrementally until at least one volatile component is below its partial pressure dew point and returns to its liquid state. As used herein, “dew point” refers to the temperature to which a portion of vapor must be cooled, at a constant barometric pressure, for the vapor to condense into liquid. If the mixture 340 comprises biodiesel, this liquid fraction would include the ester material, and may also contain similar boiling point materials such as glycerin. In this case, the condensed fraction can be further treated by methods known in the art to separate materials such as glycerin from the ester material. The condensed distilled volatile components may be collected in a product collection vessel 440.

The distillation alcohol entering the condenser 420 is preferably kept above its condensation temperature and in its vapor phase. The distillation alcohol used in the esterification reaction is preferably extracted at this stage as the gas saturation point is reached and purged from the system (e.g., for eventual recycle). The distillation alcohol used in the distillation process may then be re-heated and re-charged back into the partial pressure stripping vessel 280 to effect volatile material stripping. The non-volatile soluble and insoluble components may be removed from the stripping vessel 280, for example, as solids (or thickened slurry) through a discharge port 400 (not shown) in the stripping vessel. For example, the non-volatile components may be removed from the stripping vessel 280 by screw auger or some other device to prevent the build up of solids. Preferably, the non-volatile components are removed from the stripping vessel 280 from the bottom of the stripping vessel 280.

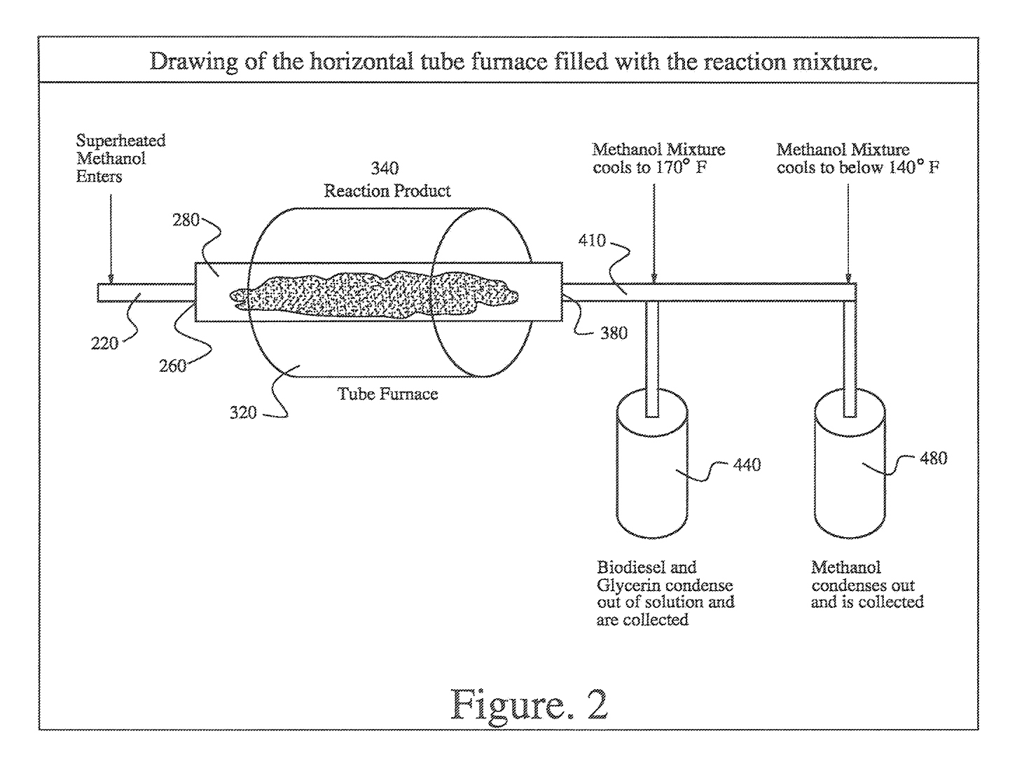

In another embodiment, a method and apparatus for separating volatile components of a mixture from non-volatile components is illustrated in FIG. 2. FIG. 2 is a diagram of a stripping vessel 280 filled with a transesterfication reaction product of dried distillers grains (DDGs). DDGs contain approximately ten percent of lipid material. These lipids can be converted into biodiesel and glycerin by adding methanol and a catalyst or under methanol supercritical conditions. The resulting product after reaction is clay-like in nature. This clay-like product contains the biodiesel and glycerin, unreacted glycerides, free fatty acids, proteins, amino acids, fiber, cellulose and sugars or sugar derivatives.

The mixture 340, comprising the clay-like material, is placed into a stripping vessel 280, here a tube, through an intake port. The stripping vessel 280 is then heated to a temperature of about 400° F. (204° C.) using a mixture heating element 320, which in FIG. 2 is a horizontal tube furnace. The stripping vessel 280 defines a distillation alcohol port 260, through which superheated methanol at a temperature of 350-450° F. (177-232° C.) enters the stripping vessel 280 containing the mixture 340 of clay-like reaction product. The distillation alcohol port 260 is connected to a distillation alcohol supply line 220.

The volatile biodiesel and glycerin are stripped from the mixture 340 of clay-like reaction product and carried off with the methanol vapor stream. The resulting vapor stream exits the stripping vessel 280 through an exit port 380 connected to a product outlet line 410. The resulting vapor stream is then cooled to approximately 170° F. (77° C.) by a condenser 420 (not shown). At this temperature the biodiesel and glycerin will condense out of the vapor stream and can be collected in a product collection vessel 440. The remaining heated methanol can be further cooled in order to condense a portion of the methanol (i.e. the excess used in the reaction). The condensed methanol can be collected in a distillation alcohol collection vessel 480. The remaining methanol vapor stream can be reheated and cycled back into the stripping vessel 280 through a distillation alcohol recycle port 460 (not shown).

Typical results of this experiment indicate that 10-15% of the distillation vapor stream will be composed of the biodiesel and glycerin and the other 85-90% of the distillation vapor stream will be methanol. After the first condensation step the condensed liquid will be composed of about 90% biodiesel and 10% glycerin with some water vapor that forms in the reaction. The vapor phase will be approximately 100% methanol.

For further illustration of the methods of the present invention, the following example is offered by way of illustration, and is not meant to be limiting in any way.

### Example 1

A mixture composed of 10% protein (w/w), 10% amino acids (w/w), 10% triglycerides (w/w), 10% cellulose (w/w), 10% lecithin (w/w) and 50% biodiesel (w/w) was heated to 420° F. (216° C.). The heated mixture was then contacted with methanol that had been superheated to 380° F. (193° C.), 400° F. (204° C.), or 420° F. (216° C.). The superheated methanol was bubbled through the mixture. The resulting vapor stream was condensed. The steps described above were conducted at atmospheric pressure.

The condensed material was analyzed for the presence of protein, amino acids, triglycerides, cellulose, lecithin, biodiesel and methanol. The results are shown in Table 2. The results demonstrate that the method described herein can be used to separate biodiesel from other components, such as non-volatile components, of a mixture at atmospheric pressure.

TABLE 2
Analysis of Condensed Material Using Methanol Superheated to 380° F., 400° F., or 420° F.

| Super Heated | Protein | Amino Acids | Triglycerides | Cellulose | Lecithin | Biodiesel | Methanol |
|---|---|---|---|---|---|---|---|
| Methanol | in | in | in | in | in | in | in |
| Degrees F. | condensate | condensate | condensate | condensate | condensate | condensate | condensate |
| 420 | ND | ND | ND | ND | ND | 26% | 74% |
| 400 | ND | ND | ND | ND | ND | 21% | 79% |
| 380 | ND | ND | ND | ND | ND | 9% | 91% |

ND = Not Detected

The above specification, examples and data provide a description of the methods and apparatus of the invention. Since many embodiments of the invention can be made without departing from the spirit and scope of the invention, the invention also resides in the claims hereinafter appended.

What is claimed is:

1. A method for separating at least one volatile component, comprising at least one of an alkyl ester, an alcohol, hydroxymethylfuran, dimethylfuran, methyl tetrahydrofuran, a polyhydric alcohol, or a reduction product of a polyhydric alcohol, from at least one non-volatile component in a mixture, said method comprising:
heating the mixture to between 150° C. and 250° C.;
contacting the mixture with a distillation alcohol in a gaseous or vapor phase, wherein the distillation alcohol is superheated; and
distilling at least a portion of the at least one volatile component from the mixture in combination with the distillation alcohol.

2. The method of claim 1, wherein the mixture is contacted with the distillation alcohol at atmospheric pressure.

3. The method of claim 1, wherein the at least one volatile component comprises an alkyl ester and the distillation alcohol to alkyl ester molar ratio is in the range of 1:1 to 500:1.

4. The method of claim 1, wherein the at least one volatile component comprises glycerol and the distillation alcohol to glycerol molar ratio is in the range of 1:1 to 500:1.

5. The method in claim 1, wherein the distillation alcohol partial vapor pressure is in the range of 100 mm Hg (about 13.3 kPa) to 7,600 mmHg (about 1011 kPa).

6. The method of claim 1, further comprising separating the distillation alcohol from the at least one distilled volatile component after distilling at least a portion of at least one volatile component.

7. The method of claim 6, wherein the at least one distilled volatile component is separated from the distillation alcohol by reducing the temperature of the at least one distilled volatile component below a dew point of the at least one distilled volatile component.

8. The method of claim 6, further comprising reheating the distillation alcohol after separating the distillation alcohol from the at least one distilled volatile component and recycling the distillation alcohol.

9. The method of claim 1, further comprising continuously removing at least a portion of the non-volatile component from the mixture after distilling at least a portion of at least one volatile component.

10. The method of claim 9, wherein at least a portion of the non-volatile component is continuously removed from the mixture using a screw auger.

11. The method of claim 1, wherein the mixture comprises biodiesel.

12. The method of claim 1, wherein the mixture is contacted with the distillation alcohol under a moderate vacuum.

13. The method of claim 1, wherein the mixture comprises less than about 50 wt % volatile components prior to heating.

14. The method of claim 1, wherein the mixture comprises up to about 100% of volatile components prior to heating.
